(19) United States
(12) Patent Application Publication
(10) Pub. No.: US 2011/0050078 A1
(43) Pub. Date: Mar. 3, 2011

(54) IMAGE DISPLAY APPARATUS

(75) Inventors: Akira Hayama, Sagamihara-shi (JP); Takayuki Ogawara, Atsugi-shi (JP)

(73) Assignee: CANON KABUSHIKI KAISHA, Tokyo (JP)

(21) Appl. No.: 12/858,908

(22) Filed: Aug. 18, 2010

(30) Foreign Application Priority Data
Aug. 26, 2009 (JP) 2009-195413

(51) Int. Cl. H01J 1/02

(52) U.S. Cl. 313/310

(57) ABSTRACT

An image display apparatus according to the present invention comprises a rear plate having electron emitting devices, a face plate having an anode electrode arranged in opposition to the electron emitting devices, and a plate-shaped spacer arranged between the rear plate and the face plate, wherein the spacer has a recess at its side of the face plate, the anode electrode has an edge located in opposition to the recess, the recess has the shape of a circular arc having a radius r, and when it is assumed that the recess has a maximum depth of d, a relation of r/d≧1 is satisfied.

### BACKGROUND OF THE INVENTION

1. Field of the Invention

The present invention relates to an image display apparatus, and in particular to the construction of a spacer that is arranged between a rear plate and a face plate inside an image display apparatus.

2. Description of the Related Art

As an image display apparatus (electron beam display apparatus) which can be made thin and light-weighted, there has been a flat panel type image display apparatus using electron emitting devices such as surface conduction type electron emitting devices. Such a display apparatus has a rear plate provided with electron emitting devices, and a face plate provided with a light emitting member which emits light by irradiation of electrons. The rear plate and the face plate are arranged in opposition to each other to form a vacuum vessel by sealing their peripheral edge portions through a frame member. An anode electrode, which is laminated on the light emitting member and to which a high electric potential is applied, is formed on the face plate. Electrons emitted from each electron emitting device are drawn to the anode electrode, and irradiated to a predetermined location of the light emitting member. As a result, a desired image is displayed. In general, a high electric potential of from several hundreds volts to several kilovolts is applied to the anode electrode in order to improve the brightness of the display apparatus, in addition to the purpose of irradiating electrons to a predetermined location of the light emitting member.

In order to prevent deformation or damage of the rear plate and the face plate due to an air pressure difference between the inside and outside of the display apparatus, plate-like support members called spacers are arranged in the interior of the display apparatus. The spacers are arranged in contact with the anode electrode so as to support a pressure force due to the air pressure difference between the inside and outside of the display apparatus.

### SUMMARY OF THE INVENTION

As stated above, a high electric potential of from several hundreds volts to several kilovolts is generally applied to the anode electrode. Further, a gap between the rear plate and the face plate is made as small as possible for the purpose of thinning the display apparatus. For this reason, quite a high electric field usually arises inside the display apparatus. The spacers are in contact with the anode electrode, and an electric potential at an anode electrode side end face of each spacer is generally equal to the electric potential of the anode electrode. Therefore, an electric discharge between each spacer and the anode electrode does not take place relatively easily. However, it is difficult to make both of them in complete intimate contact with each other, and in actuality, inevitable minute gaps exist between the spacers and the anode electrode, so an electric discharge can occur.

The present invention provides a technique for suppress an electric discharge between a plate-shaped spacer and an anode electrode in an effective manner in an image display apparatus which has a face plate provided with the anode electrode, and the plate-shaped spacer.

A first image display apparatus according to the present invention comprising:

a rear plate having electron emitting devices;

a face plate having an anode electrode arranged in opposition to the electron emitting devices; and

a plate-shaped spacer arranged between the rear plate and the face plate,

wherein the spacer has a recess at its side of the face plate,

the anode electrode has an edge located in opposition to the recess,

the recess has the shape of a circular arc having a radius r, and

when it is assumed that the recess has a maximum depth of d, a relation of r/d≧1 is satisfied.

A second image display apparatus according to the present invention comprising:

a rear plate having electron emitting devices;

a face plate having an anode electrode arranged in opposition to the electron emitting devices; and

a plate-shaped spacer arranged between the rear plate and the face plate,

wherein the spacer has a recess at its side of the face plate,

the anode electrode has an edge located in opposition to the recess,

the recess has a shape which is formed of a first circular arc portion, a second circular arc portion, and a tangent line of the first and second circular arc portions that connects between the first circular arc portion and the second circular arc portion, and

when it is assumed that the first circular arc portion has a radius of r1, the second circular arc portion has a radius of r2, the first circular arc portion has a maximum depth of d1 and the second circular arc portion has a maximum depth of d2, a relation of r1/d1≧1 and r2/d2≧1 is satisfied.

A third image display apparatus according to the present invention comprising:

a rear plate having electron emitting devices;

a face plate having an anode electrode arranged in opposition to the electron emitting devices and having an electric potential regulating electrode arranged at a position apart from the anode electrode; and

a plate-shaped spacer arranged between the rear plate and the face plate,

wherein the spacer has a recess at its side of the face plate,

a portion of the face plate between the anode electrode and the electric potential regulating electrode opposes to the recess,

the recess has a shape which is formed of a first circular arc portion, a second circular arc portion, and a tangent line of the first and second circular arc portions that connects between the first circular arc portion and the second circular arc portion, and

when it is assumed that the first circular arc portion has a radius of r1, the second circular arc portion has a radius of r2, the first circular arc portion has a maximum depth of d1 and the second circular arc portion has a maximum depth of d2, a relation of r1/d1≧1 and r2/d2≧1 is satisfied.

The inventor of the subject application has found out that an electric discharge between a spacer and an anode electrode is liable to take place at an edge of the anode electrode. This is considered due to the fact that protrusions such as “burrs”, etc., are liable to be generated in the edge of the anode electrode during a manufacturing process, and the concentration of an electric field is also liable to occur due to the shape thereof. In the present invention, it is constructed such that the spacer has a recess formed to open at its edge opposing to the face plate and to spread in an inner direction of the surface of the spacer, with an edge of the anode electrode being located inside this recess. With such an construction, it becomes easy to ensure a space between the edge of the anode electrode and the spacer. According to this, it becomes difficult to produce an electric discharge between the spacer and the anode electrode.

Incidentally, note that the plate-shaped spacer is generally formed very thin. Therefore, when the spacer is built into the image display apparatus, positioning is made while pulling the spacer in a longitudinal direction thereof so that the spacer can be fixedly held at a predetermined position while keeping a planar shape without being curved. For this reason, in the spacer, there is generated a tensile stress in the longitudinal direction thereof. Further, even after the building in of the spacer, a tensile stress can also be generated in the spacer at the time of evacuating the interior of the panel (i.e., the display apparatus) to a vacuum, or at the time of the conveyance of the panel in the manufacturing process, etc. In cases where a recess as mentioned above is formed in the spacer, it is considered that a stress concentration will arise, with the result that the tensile strength of the spacer can not be obtained to a sufficient extent. However, the shape of the recess is an arc of a circle, and besides, a radius r of the circle is equal to or larger than a maximum depth d of the recess (i.e., r/d≧1), as a consequence of which the magnitude of the stress concentration is mitigated. That is, the practical tensile strength of the recessed spacer is not decreased greatly as compared with the case where the spacer has no recess. Thus, in the present invention, it becomes difficult to produce an electric discharge between the spacer and the anode electrode, and in addition thereto, there can be expected an effect that it is able to prevent a sharp decrease in the tensile strength of the spacer due to the formation of the recess.

According to the present invention, in the image display apparatus which has the face plate provided with the anode electrode, and the plate-shaped spacer, it becomes possible to suppress an electric discharge between the spacer and the anode electrode in an effective manner.

Further features of the present invention will become apparent from the following description of exemplary embodiments with reference to the attached drawings.

### BRIEF DESCRIPTION OF THE DRAWINGS

FIG. 1 is a perspective view of an image display apparatus according to a example of the present invention.

FIG. 2 is a plan view of a face plate of the image display apparatus shown in FIG. 1, as viewed in a direction of line A-A in FIG. 1.

FIGS. 3A and 3B are cross sectional views showing different shapes of a recess in a spacer.

FIGS. 4A through 4C are conceptual diagrams showing various shapes of the recess in the spacer, respectively, in a first example of the present invention.

FIG. 5 is a view showing the relation between a shape parameter of the recess and the fracture strength of the spacer.

FIGS. 6A through 6C are conceptual diagrams showing various shapes of a recess in a spacer, respectively, in a second example of the present invention.

### DESCRIPTION OF THE EMBODIMENTS

An image display apparatus of the present invention includes a display apparatus provided with electron emitting devices, and so on. In such an image display apparatus, support members (spacers) are arranged between a rear plate provided with electron emitting devices, and a face plate provided with a light emitting member (e.g., phosphor), and such a structure is a preferable form to which the present invention is applied. Hereinafter, an image display apparatus according to an embodiment of the present invention will be explained while referring to the accompanying drawings. In the following, a display apparatus provided with electron emitting devices will be explained by way of example.

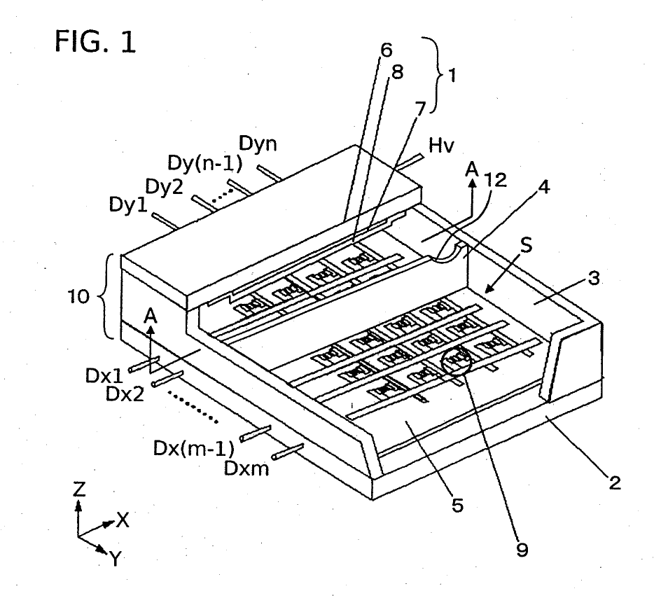

FIG. 1 is a perspective view showing an example of the construction of the image display apparatus (hereinafter, referred to as a display apparatus 10). In FIG. 1, the display apparatus 10 is shown with a part thereof being cut away. The display apparatus 10 has a rear plate 2 to which an electron source substrate 5 is fixedly secured, and a face plate 1 which is arranged in opposition to the rear plate 2. A lot of electron emitting devices 9 are formed on the electron source substrate 5. On the electron source substrate 5, there are arranged the electron emitting devices 9 in a plurality of rows and columns, and the plurality of electron emitting devices 9 are subjected to simple matrix wiring by means of X direction wirings Dx1 through Dxm, and Y direction wirings Dy1 through Dyn. As the electron emitting devices 9, there can be used surface conduction type electron emitting devices, field emission type electron emitting devices, MIM (Metal Insulator Metal) type electron emitting devices, and so on.

The face plate 1 is provided with a glass substrate 6, a fluorescent film 7 which is formed on an inner surface of the glass substrate 6 and functions as a light emitting member, and an anode electrode 8 which is formed on the glass substrate 6 and the fluorescent film 7 so as to cover the fluorescent film 7. The anode electrode 8 is arranged in opposition to the electron emitting devices 9. An anode potential is supplied to the anode electrode 8 from a high-voltage terminal Hv. Electron beams emitted from the electron emitting devices 9 formed on the rear plate 2 are accelerated by the anode potential supplied to the face plate 1, and are drawn to the face plate 1 to collide with the fluorescent film 7. As a result, a phosphor constituting the fluorescent film 7 emits light so that an image is displayed on the face plate 1. A metal film, if used as the anode electrode 8, will also function as a metal back for improving the utilization rate of light, by reflecting a part of the light from the fluorescent film 7.

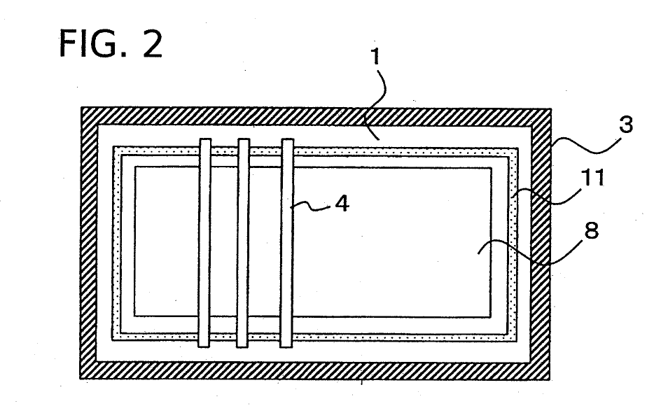

FIG. 2 is a plan view (look-up view) of the face plate, as seen in a direction of line A-A in FIG. 1. Referring to FIG. 2, on the face plate 1, there is formed an electric potential regulating electrode 11 which is arranged so as to surround the periphery of the anode electrode 8, and which is positioned apart from the anode electrode 8. However, the electric potential regulating electrode 11 may be omitted. Although the electric potential regulating electrode 11 is regulated to an earth potential, it is not limited to the earth potential as long as it is regulated to an electric potential lower than the anode potential. The electric potential regulating electrode 11 restricts a space of a high electric potential that is formed around the periphery of the anode electrode 8. The shape of the electric potential regulating electrode 11 is not limited in particular. In order to receive a high electric potential from a rear plate 2 side, for example, the electric potential regulating electrode may be formed so as to surround an unillustrated electric potential take-out part which is formed on the outer peripheral part of the face plate 1. The height of the electric potential regulating electrode 11 from a surface of the glass substrate 6 of the face plate 1 is almost equal to the height of the anode electrode 8 from the surface of the glass substrate 6 of the face plate 1.

A support frame 3 is arranged between the face plate 1 and the rear plate 2, so that an envelope (reduced pressure space S) is formed by the face plate 1, the rear plate 2 and the support frame 3. The face plate 1 and the support frame 3 as well as the rear plate 2 and the support frame 3 are respectively joined to each other by means of frit glass.

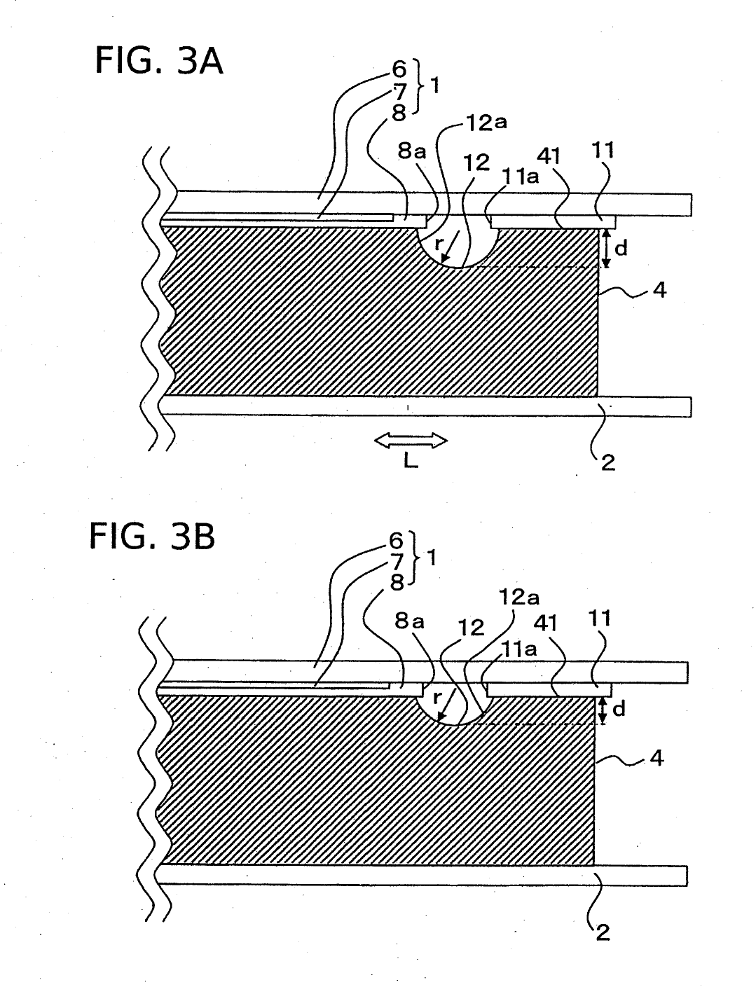

The support members called spacers 4 are arranged between the face plate 1 and the rear plate 2. In the following, the construction of each spacer 4 will be described in detail with reference to FIGS. 3A and 3B which are cross sectional views of the display apparatus. FIG. 3A is a cross sectional view of the display apparatus according to the embodiment of the present invention obtained along a surface which is parallel to a longitudinal direction of each spacer and vertical to a display surface of the display apparatus.

Each spacer 4 is a plate-shaped member which has a high resistance film (not shown) for the prevention of static charges deposited on a surface of an insulating substrate. Each spacer 4 has a lower side fixedly connected to X-direction wirings Dx1 through Dxm, as shown in FIG. 1. Each spacer 4 has an upper side 41 arranged in opposition to the anode electrode 8 and the electric potential regulating electrode 11, and in contact with the anode electrode 8 and the electric potential regulating electrode 11, as shown in FIG. 3A. Though it is needless to say, in an embodiment in which the electric potential regulating electrode 11 is not provided, the upper side 41 of each spacer 4 is in opposition to the anode electrode 8, and is also in contact with the anode electrode 8. The inventor of the subject application observed the degree of contact of the spacers 4 with the other members by disassembling the display apparatus after evacuating the interior of the display apparatus (the interior of the envelope which is comprised of the face plate 1, the rear plate 2 and the support frame 3). Marks of crush due to the atmospheric pressure remained in those parts of the anode electrode 8 and the electric potential regulating electrode 11 which were in contact with the spacers 4, and it was verified that the spacers 4 were in contact with these members. The spacers 4 are not arranged on all the X-direction wirings Dx1 through Dxm, but are arranged one per a plurality of X-direction wirings. The spacers 4 have a sufficient strength against the atmospheric pressure. Electric potentials supplied to the rear plate 2 and the face plate 1 are applied to the upper and lower sides of each spacer 4, whereby a potential distribution is formed on the surface of the spacer 4.

Each spacer 4 has a recess 12 (notch) formed on its side (upper side 41) of the face plate 1. This recess 12 has the shape of a circular arc having a radius r. In this embodiment, the shape of the recess is assumed to be a circular arc with a central angle of 180 degrees, i.e., a semicircle. That is, it is assumed that when the maximum depth of the recess 12 with reference to the upper side 41 is set to d, a relation of r/d=1 is satisfied. However, the central angle of the circular arc may be less than 180 degrees, as shown in FIG. 3B. That is, a relation of r/d>1 may instead be satisfied. Thus, the shape of the recess 12 should just satisfy a relation of r/d≧1. As stated above, a tensile stress is applied to each spacer 4 in its longitudinal direction L by means of the fixing of the spacer 4, the evacuation of air in the panel, the conveyance of the panel, etc. However, by making the shape of the recess 12 into a shape in which the relation of r/d≧1 is satisfied, the factor of stress concentration can be suppressed to be small, and the reduction of the tensile strength (fracture strength) in the longitudinal direction of the spacer 4 can be minimized.

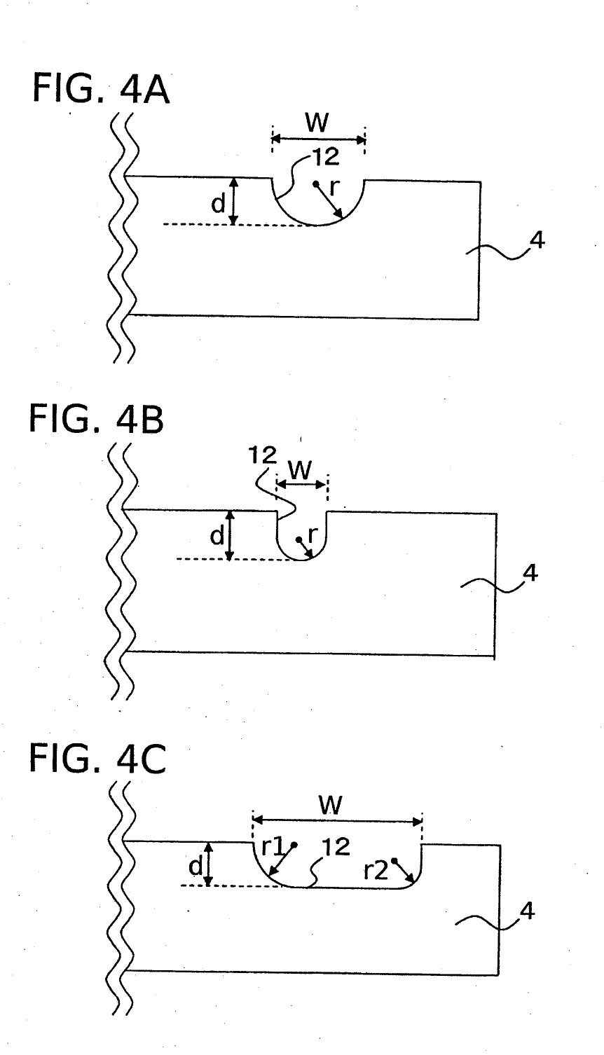

The recess 12 can be formed by means of any arbitrary method such as grinding with the use of a diamond grinding wheel. A portion of the face plate 1 between the anode electrode 8 and the electric potential regulating electrode 11 is in opposition to the recess 12 through a gap. In the neighborhood of the portion of the face plate 1 between the anode electrode 8 and the electric potential regulating electrode 11, a surface of the glass substrate 6 can be exposed to the gap. But, the surface of the glass substrate 6 can be covered with a high resistance film connecting the anode electrode 8 and the electric potential regulating electrode 11 each other. As shown in FIGS. 3A and 3B, an edge 8a of the anode electrode 8 and an edge 11a of the electric potential regulating electrode 11 (i.e., an edge of the electric potential regulating electrode 11 in opposition to the edge 8a of the anode electrode electric 8) are located in opposition to the recess 12. In other words, the recess 12 is formed so that the edge 8a of the anode electrode 8 and the edge 11a of the electric potential regulating electrode 11 can be exposed. In this way, the anode electrode 8 and the electric potential regulating electrode 11 is in opposition to the recess 12. Specifically, the length W in the spacer's longitudinal direction of the recess 12 (i.e., the width of the recess) shown in FIGS. 4A through 4C should just be made longer than the distance between the edge 8a and the edge 11a.

An electric potential in the contact part of each spacer 4 with the anode electrode 8 is substantially equal to the electric potential of the anode electrode, and an electric potential in the contact part of each spacer 4 with the electric potential regulating electrode 11 is substantially equal to the electric potential of the electric potential regulating electrode 11. However, it is considered that the anode electrode 8 and each spacer 4 are in contact with each other as a whole, but in the contact parts of the anode electrode 8 and each spacer 4, there actually exist minute gaps resulting from various causes such as manufacturing errors, errors at the time of assembly, surface roughness of the contact parts, and so on. Similarly, it is also considered that although the electric potential regulating electrode 11 and each spacer 4 are in contact with each other as the whole, minute gaps actually exist in the contact parts of the anode electrode 8 and the electric potential regulating electrode 11. Such minute gaps produce a potential difference between the anode electrode 8 and each spacer 4 or between the electric potential regulating electrode 11 and each spacer 4, thus resulting in a cause of electric discharge. In particular, protrusions such as “burrs”, etc., are liable to be formed in the edge 8a of the anode electrode 8 and the edge 11a of the electric potential regulating electrode 11, so electric field concentrations will tend to occur due to geometric reasons. Therefore, electric discharge is liable to occur in particular between the edge 8a and each spacer 4 as well as the edge 11a and each spacer 4.

In this embodiment, these edges 8a, 11a are located in opposition to the recess 12, so it is possible to obtain sufficient distances for preventing electric discharge between the edges 8a, 11a and each spacer 4 in an easy manner.

In the following, the present invention will be explained in further detail by taking some examples. In each example described below, there have been used a multi-electron beam source which includes a plurality of (i.e., n×m (n=480, m=100)) surface conduction type electron emitting devices each of which has an electron emission part on an electric conductive thin film between its electrodes and which are arranged in a matrix fashion so as to be connected to m row-direction wirings and n column-direction wirings.

### First Example

An image display apparatus according to a first example has the same construction as that of the image display apparatus which has been explained by using FIG. 1, and includes phosphors of RGB and a black matrix so as to provide a color presentation. The distance between an anode electrode 8 and an electric potential regulating electrode 11 was set to 4 mm. The anode electrode 8 served as a metal back, and the electric potential of the electric potential regulating electrode 11 was set to earth potential.

A base material (i.e., a plate-shaped base material having a height of 2 mm and a width of 0.2 mm) in the form of product No. PD200 manufactured by Asahi Glass Co., Ltd. was prepared as a spacer 4, and a recess 12 was formed by cutting with the use of a diamond grinding wheel. The recess 12 took shapes as shown in FIGS. 4A through 4C. The radius r of the recess 12 was set in the range of 0.15 mm to 15 mm, and the maximum depth d of the recess 12 was set to 0.6 mm. FIG. 4A shows a case in which the radius r is 0.6 mm, the maximum depth d is 0.6 mm, and the length W in the spacer's longitudinal direction of the recess 12 (i.e., the width of the recess) is 1.2 mm. FIG. 4B shows a case in which r=0.3 mm, d=0.6 mm, and W=0.6 mm. FIG. 4C shows an example in the case where the recess 12 has a shape which is formed by a first circular arc (i.e., a left-hand side corner of the recess 12), a second circular arc (i.e., a right-hand side corner of the recess 12), a common tangent line of the first and second circular arcs connecting them. Specifically, FIG. 4C shows the example in which the radius r1 of the first circular arc is equal to 0.6 mm, the radius r2 of the second circular arc is equal to 0.3 mm, d=0.6 mm, and W=2.4 mm.

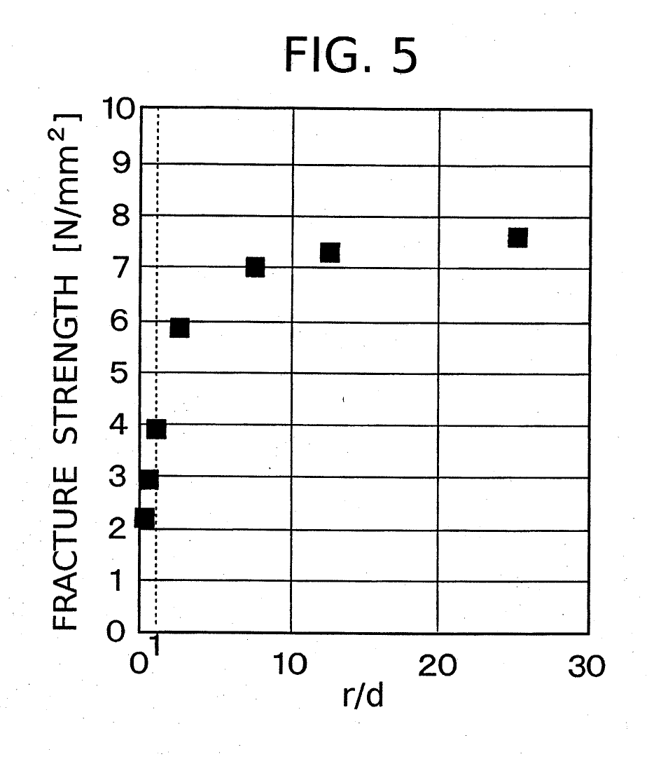

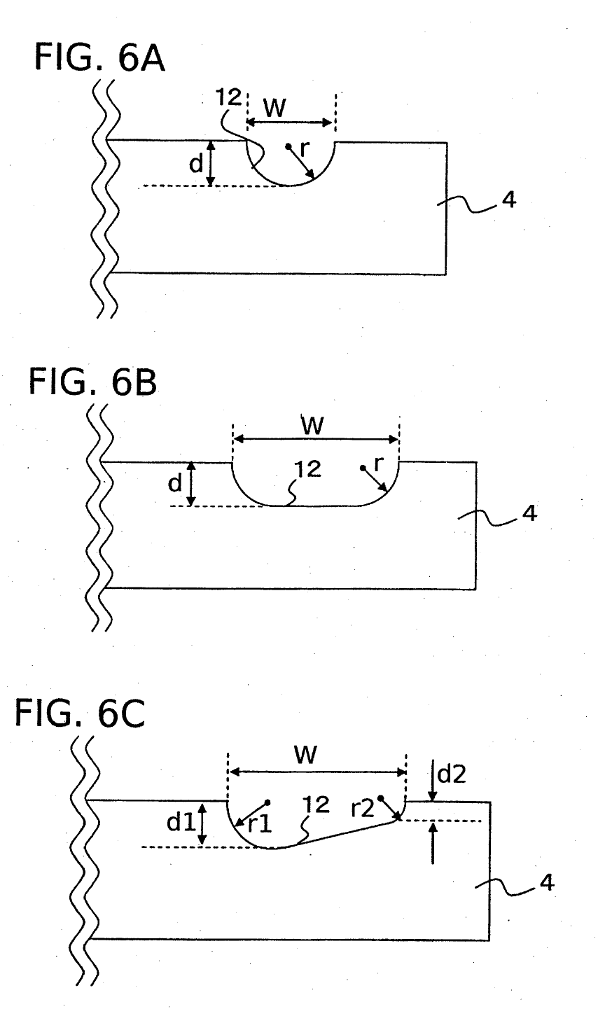

The spacers thus formed were subjected to tensile tests, and the relation between the r/d and the fracture strength thereof was examined. The result is shown in FIG. 5. In the example shown in FIG. 4C, the ratio of radius to depth is represented by the ratio r2/d of the second circular arc in which the factor of stress concentration becomes large. The fracture strength is an average value as a result of ten times of tests. From this result, it is found that as r/d (i.e., r2/d) becomes smaller than 1, the strength decreases rapidly (FIGS. 4B and 4C are examples in which r/d<1). This is because when r/d becomes smaller than 1, stress concentrates on an circular arc. In an image display apparatus using spacers each of which has a structure to satisfy a relation of r/d≧1, as shown in FIG. 4A, it was able to be verified that the spacers were fixed at predetermined locations to provide good image quality while maintaining their flat plate shapes without being destroyed. Here, note that even in cases where the first circular arc and the second circular arc are mutually different in shape from each other, sufficient strength can be ensured if a relation of r1/d1≧1 and r2/d2≧1 is satisfied, as shown in FIG. 6C. Here, d1 is the maximum depth of a first circular arc portion of the recess 12, and d2 is the maximum depth of a second circular arc portion of the recess 12.

### Second Example

In a second example, the relation between the width W of the recess, and the radii r, r1 and r2 was considered. A base material (i.e., a plate-shaped base material having a height of 2 mm and a width of 0.2 mm) in the form of product No. PD200 manufactured by Asahi Glass Co., Ltd. was prepared as a spacer 4, similar to the above-mentioned first example, and a recess 12 was formed by cutting with the use of a diamond grinding wheel, as in the first example. The recess 12 was used which took shapes as shown in FIGS. 6A through 6C. FIG. 6A shows a case in which r=0.6 mm, d=0.6 mm, and W=1.2 mm. FIG. 6B shows an example in the case where the central angles of first and second circular arcs are 90 degrees, respectively, and the radii thereof are both equal to each other (i.e., r1=r2=d1=d2). Specifically, FIG. 6B shows a case in which r1=r2=0.6 mm, d1=d2 0.6 mm, and W=2.4 mm. FIG. 6C shows a case in which r1=0.6 mm, d1=0.6 mm, r2=0.3 mm, d2=0.3 mm, and W=2.4 mm. Here, note that in the examples shown in FIGS. 6A through 6C, a relation of r/d≧1 or a relation of r1/d1≦1 and r2/d2≦1 is satisfied.

The spacers 4 thus formed were subjected to tensile tests, and the relations between the W/r, W/r1, W2 and the fracture strength thereof were considered. The fracture strength is an average value as a result of ten times tests. When W/r1 or W/r2 became smaller than 5, it was found out that the fracture strength becomes low. This is considered due to the following reason. When W/r1 and W/r2 are both equal to or larger than 5, the first circular arc and the second circular arc on which stress concentrations occur are apart from each other, but when W/r1 or W/r2 becomes smaller than 5, the first circular arc and the second circular arc become close to each other, so that the stresses produced in the respective circular arcs come to mutually influence each other, as a result of which the stress produced in the recess increases. In the case of W/r1=W/r2=2, the first circular arc and the second circular arc come to continue to each other (i.e., the locations on which stress concentrations occur converge to a single point), as shown in FIG. 6A. In an image display apparatus using spacers each of which has a structure to satisfy a relation of W/r1≧5 and W/r2≧5, it was able to be verified that the spacers were fixed at predetermined locations to provide good image quality while maintaining their flat plate shapes without being destroyed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-195413, filed on Aug. 26, 2009, which is hereby incorporated by reference herein in its entirety.

What is claimed is:

1. An image display apparatus comprising:
a rear plate having electron emitting devices;
a face plate having an anode electrode arranged in opposition to the electron emitting devices; and
a plate-shaped spacer arranged between the rear plate and the face plate,
wherein the spacer has a recess at its side of the face plate,
the anode electrode has an edge located in opposition to the recess,
the recess has the shape of a circular arc having a radius r, and
when it is assumed that the recess has a maximum depth of d, a relation of r/d≧1 is satisfied.

2. The image display apparatus according to claim 1, wherein a relation of r/d=1 is satisfied.

3. An image display apparatus comprising:
a rear plate having electron emitting devices;
a face plate having an anode electrode arranged in opposition to the electron emitting devices; and
a plate-shaped spacer arranged between the rear plate and the face plate,
wherein the spacer has a recess at its side of the face plate,
the anode electrode has an edge located in opposition to the recess,
the recess has a shape which is formed of a first circular arc portion, a second circular arc portion, and a tangent line of the first and second circular arc portions that connects between the first circular arc portion and the second circular arc portion, and
when it is assumed that the first circular arc portion has a radius of r1, the second circular arc portion has a radius of r2, the first circular arc portion has a maximum depth of d1 and the second circular arc portion has a maximum depth of d2, a relation of r1/d1≧1 and r2/d2≧1 is satisfied.

4. The image display apparatus according to claim 3, wherein a relation of r1=r2=d1=d2 is satisfied.

5. The image display apparatus according to claim 3, wherein when it is assumed that the recess has a width of W, a relation of W/r1≧5 and W/r2≧5 is satisfied.

6. The image display apparatus according to claim 1, wherein
the face plate has an electric potential regulating electrode arranged at a position apart from the anode electrode, and
the electric potential regulating electrode has an edge that is arranged in opposition to the edge of the anode electrode at a position in opposition to the recess.

7. The image display apparatus according to claim 3, wherein
the face plate has an electric potential regulating electrode arranged at a position apart from the anode electrode, and
the electric potential regulating electrode has an edge that is arranged in opposition to the edge of the anode electrode at a position in opposition to the recess.

8. An image display apparatus comprising:
a rear plate having electron emitting devices;
a face plate having an anode electrode arranged in opposition to the electron emitting devices and having an electric potential regulating electrode arranged at a position apart from the anode electrode; and
a plate-shaped spacer arranged between the rear plate and the face plate,
wherein the spacer has a recess at its side of the face plate,
a portion of the face plate between the anode electrode and the electric potential regulating electrode opposes to the recess,
the recess has a shape which is formed of a first circular arc portion, a second circular arc portion, and a tangent line of the first and second circular arc portions that connects between the first circular arc portion and the second circular arc portion, and
when it is assumed that the first circular arc portion has a radius of r1, the second circular arc portion has a radius of r2, the first circular arc portion has a maximum depth of d1 and the second circular arc portion has a maximum depth of d2, a relation of r1/d1≧1 and r2/d2≧1 is satisfied.

9. The image display apparatus according to claim 8, wherein when it is assumed that the recess has a width of W, a relation of W/r1≧5 and W/r2≦5 is satisfied.

10. The image display apparatus according to claim 8, wherein the anode electrode and the electric potential regulating electrode opposes to the recess.
